(19) United States
(12) Patent Application Publication
(10) Pub. No.: US 2007/0083859 A1
(43) Pub. Date: Apr. 12, 2007

(54) Software manufacturing factory

(75) Inventors: Mark L. Fussell, Palo Alto, CA (US); Brian J. Schultheiss, Irvine, CA (US)

Correspondence Address: Bo-In Lin, 13445 Mandoli Drive, Los Altos Hills, CA, 94022, US

(73) Assignee: Velidom, Inc.

(21) Appl. No.: 11/248,048

(22) Filed: Oct. 12, 2005

(51) Int. Cl. G06F 9/44

(52) U.S. Cl. 717/168

(57) ABSTRACT

This invention discloses an automated software development system that includes an automated version control and evaluation processing platform for automatically evaluating a quality and value of a plurality of software changes and corresponding versions of a software system for automatically controlling an automated software development and change process of the software system. The automated version control and evaluation processing platform further includes a database for storing statistic and relevant data including the quality and value of the plurality of software changes and versions of the software system. The automated version control and evaluation-processing platform further applies the statistic and relevant data for automatically controlling an automated software development and change process of the software system.

### FIELD OF THE INVENTION

This invention generally relates to software development. More particularly, this invention is related to a machine that executes an improved process of creating changes to a software system, applying those changes to the software system, and logging, evaluating, and subsequently utilizing that change and software system.

### BACKGROUND OF THE INVENTION

The software industry has a fundamental problem that the processes for software development, update, upgrade, and maintenance are no more “industrialized” than they were in 1980. These processes have continued to stay as crafts, where people must plan and orchestrate a collection of tasks and properly utilize the results of those tasks for the processes to be successful. The processes are ruled by the particulars of individuals, teams, and specific circumstances surrounding the software system. Failure to execute processes properly is quite common (even “normal”), causing development to be unproductive and unreliable. Even when best practices exist, significant skill and years of experience by the whole team is required to apply those best practices correctly. This is rarely available to companies that need to do software development. As a result, the industry has come to accept this norm of unproductive and unreliable system development, frequent project failure, and even a very low return on investment (ROI) for successful projects.

Software systems have made progress in the last twenty years, but that is primarily due to the characteristics of any software system: one can freely replicate and disseminate a software system if that matches the goal of the creator (e.g. the HTTP and HTML specifications and products like the Apache server). Some highly skilled individuals and small teams have created extremely valuable software available to everyone—usually in specific technology areas. But more commonly, building new software systems or augmenting existing systems continues to be burdened with very poor productivity and high costs for achieving systems with significant business value. Software development practices and technologies have not advanced to higher levels of productivity than were present when the first integrated development environments and team tools were created (e.g. Smalltalk-80, with its object-oriented language and its IDE that facilitated very productive software development). They are just more ubiquitous and less expensive. But now a much broader pool of developers, pulled together into larger teams, and commonly dispersed geographically as well, are being tasked to build and augment complex software systems. The tools and processes are not significantly better, while the projects are more demanding on the team members. This dichotomy is the core cause for development projects to have a very high chance of failure and a very low return on investment (ROI). Further, the resulting systems of any project can unexpectedly have very poor business value and be functionally unstable when put into production.

At the core of the problem, conventional software technologies for making changes to computer programs require significant amounts of human orchestration, involvement, and skill. This skilled human involvement is not only required in the design and problem solving areas of software development, it is also required in the “manufacturing” processes of applying changes to a system, verifying the resulting quality of the system, and responding appropriately to that quality level. These processes can be extremely complicated and encumbering on the people involved because software development frequently involves many people developing changes simultaneously. Further, due to software's ability to share functionality, changes can have unexpected negative impacts on each other even when the changes appear to be independent of each other. Further, in general practice, system developers accumulate many significant changes to their software systems before any process (human or automated) attempts to build a new system and examine the characteristics of that new system for whether it had progressed or regressed compared to different versions. And after this examination, so many changes, so much time, and so much effort has been applied that recovery from regression is very difficult and extremely human skill intensive again. Software processes related to manufacturing new software systems are extremely unproductive, labor intensive, and unreliable.

As an example of current best practices, refer to FIGS. 1A and 1C for a pipelined software management process for building and examining a system as a more automated process, e.g. Cruise Control or Ant Hill. However, such system as shown still has a fundamental limitation, i.e., the results of the examination are not acted upon meaningfully by the automated systems. Instead, the examination reports are given back to the System Developer to rectify the situation and given to the System Beneficiary so they have a vague feeling for the quality of the system. The current system may potentially be inferior in quality to a prior system, but there is no systematic method to control the process for assuring system versions of improved quality can be systematically achieved through each change made to the software system.

FIGS. 1B and 1D further illustrate the conventional system development process as it appears for a system. The system developers generate a plurality of changes to the system, i.e., splices, represented by VA1, VA2, VA3, and VA4 to modify a base version represented by VBASE. Applying each of these changes in succession to the base version VBASE, generates different system source versions (SSVs). At some point in time, automated and manual examination will be done on some or (rarely in common practice) all of these SSVs. FIG. 1D shows that SSV1 and SSV2 pass the tests while SSV3 and SSV4 fail the QA tests. The latency between the creation of SSV3 and the examination results for SSV3 is commonly a day or several hours with current technologies and practices. Rectifying the problem introduced with SSV3 becomes a human fire drill to pull the change introduced in SSV3 out from SSV4, try to recover, and restart the examination process. Even more commonly, the system has gone from VBASE to SSV12 before the examination is done, so there are twelve changes that could be the sources of failures and skilled human involvement will be required to isolate and remedy these defects.

Conventional software technologies have made it a human responsibility to (a) identify the specific source of the failures among many changes that are accumulated together before the examination, (b) rectify that specific failures by somehow ‘reversing’ it from the set of changes or attempting to progress without failing again, and (c) continue this activity until a new version of the system was of sufficient quality to pass examination. Every time the human fire drill is performed, productivity is significantly worsened. Every time the human fire drill is not performed, system reliability has been significantly worsened. Overall, software project ROI is being penalized due to bad manufacturing processes and missing critical automations.

The costs in team productivity and system quality due to these failures of conventional software technologies have become increasingly high. As team size grows, the overhead of orchestration and the internal dependencies grows. As team member pools broaden, individual contributors may significantly impede other team members. As team member geographic and time separation grows, poor communication quality and longer latency between a human enquiry and human response can stall development activities. As software development has become more pervasive and business critical, the necessity for improved technologies and better ROI has become critical.

Therefore, a need exists in the art of software development and quality control to provide a new and improved system configuration, process control and software test methods to enable a person of ordinary skill in the art of software development and quality control to overcome these difficulties and limitations.

### SUMMARY OF THE PRESENT INVENTION

It is therefore an object of the present invention to provide an improved system configuration and process for carrying out program changes and version control. The improved system configuration and processes provide automated test processes for quantifying the quality of a software system by subjecting the different versions of software to undergo standardized testing and grading at an atomic change level. These quantified results represented as test scores associated with the software change provide more specific knowledge about the quality of a software system and enable rapid, automated, remedy to regression and progression of the software system.

Another aspect of this invention is the more specific quantification represented by test scores associated with atomic system changes provide more in-depth and earlier knowledge of the quality of a software system. This in-depth and specific knowledge provide further bases for the QA team to gain more insights about what source of changes is causing improvements or defects to a software system. The quantified results can trace the improvements or defects to specific sources, e.g., individual software developers, specific time periods, activities, and system areas or other sources of possible defects. An improved total throughput of software changes and version updates are achievable by applying the system configuration and software change and update processes disclosed in this invention.

Another aspect of this invention is to enable a software team to more effectively utilize the machine and human resources by providing proper automations to carry out repeated test processes. Meanwhile, the automated test processes are supervised through proper human interfaces and controls by inputting testing rules to generate meaningful and practical useful test results for immediate application by the QA team of the software system.

Another aspect of this invention is to increase the confidence level associated with changing a software system through the in-depth knowledge of the quality of the software system and specific test scores provided by the automated tests. Clear, traceable and systematic tests according to different test rules are applied on multiple versions of a software system and each has a test score to provide quantifiable level of confidence about the quality of the software system. The confidence level is further enhanced because the automated test process can quickly detect if there are mistakes in changes made to the software system. With specific test scores, a mistaken change made to a software system can be quickly corrected and replaced by the correct change.

Another aspect of this invention is to more rapidly deploy new changes to a system into evaluation, acceptance, and production environments. As system beneficiary confidence increases with the automated scoring and manufacturing processes, less human involvement and time will be needed for getting an improved system into beneficiaries' hands.

Another aspect of this invention is to enable the software development and maintenance teams to improve quality of their own activities as well as the system by consistently applying source normalization transformations at the earliest times right after the program changes are generated.

Another aspect of this invention is to improve code quality and capturing of metrics through consistent and fine-grained recording of information. This captures information associated with process maturity models (e.g. CMMI) as well as information useful for development team productivity.

Another aspect of this invention is to provide an automated test system configuration and process such that a teams of ordinary skill in the art are able to share hardware resources across their different change streams.

Another important aspect of this invention is to reduce the need of human resources required for software development and maintenance and particularly reduces the need of human resources of particular software skills.

Briefly, in a preferred embodiment, the present invention discloses a data handling system that includes an automated software change and version control processing platform for applying a plurality of software changes to generate a plurality of software system versions and further automatically employing a set of software quality examination rules to evaluate a quality of each of the plurality of software system versions for automatically determining a maximum value current version among the plurality of software system versions. In a preferred embodiment, the automated software change and version control processing platform further keeps a record of the statistic and relevant data for each of the plurality of software changes and software system versions including the quality for each of the plurality of software system versions. In another preferred embodiment, the automated software change and version control-processing platform further applies the statistic and relevant data for each of the plurality of software changes and software system versions.

In a preferred embodiment, this invention further discloses a method to automated a software development process that includes a step of automatically evaluating a quality and value of a plurality of software changes and corresponding versions of a software system for automatically controlling an automated software development and change process of the software system. In a preferred embodiment, the method further includes a step of storing statistic and relevant data including the quality and value of the plurality of software changes and versions of the software system in a database. In a preferred embodiment, the method further includes a step of applying the statistic and relevant data stored in the database for automatically controlling an automated software development and change process of the software system.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A and 1C are diagrams for showing the prior art systems and FIGS. 1B and 1D are diagrams for showing the prior art processes of making software changes and test different versions of software after changes are made.

FIGS. 2A and 2B are functional block diagrams for showing two different embodiments of a software change environment of this invention.

FIGS. 3A and 3B are two diagram for illustrating the software change processes according to the processes and system configuration of this invention.

FIGS. 4A and 4B are two functional block diagrams for illustrating data flow and functional processes carried out by a software change environment disclosed in this invention.

FIGS. 5A and 5B are two functional block diagrams for illustrating data flow and functional processes carried out by a SSV generator as part of the software environment of in this invention.

FIGS. 6 to 8 are flowcharts for showing the processing steps carried out by a splice receiver, a splice applier, and a system examiner as implemented in a software change environment of this invention.

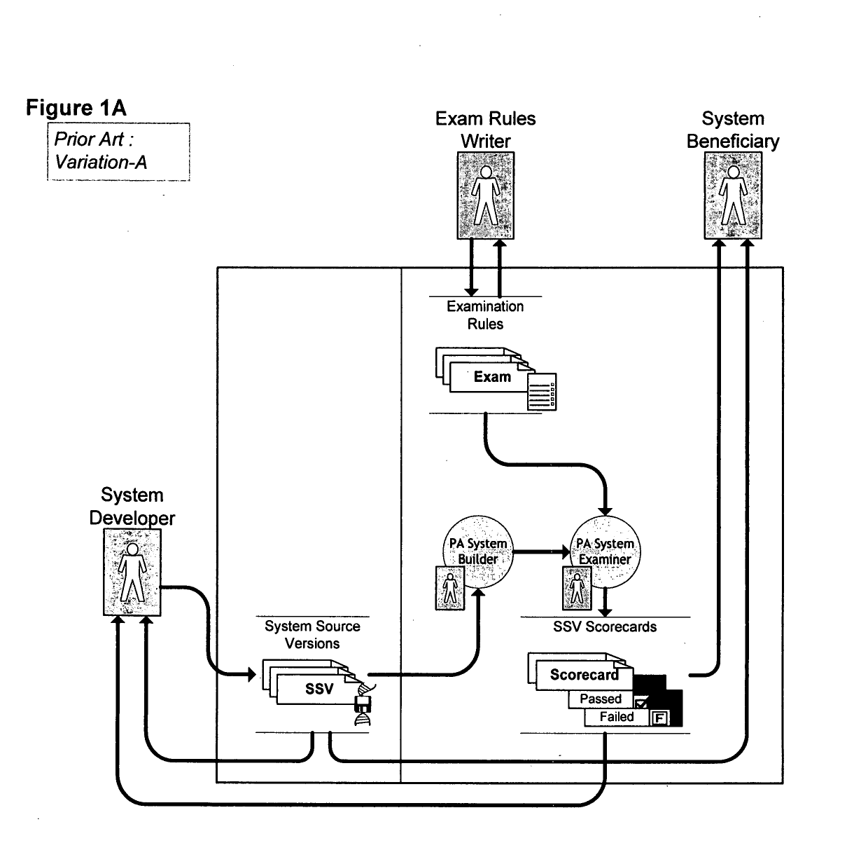

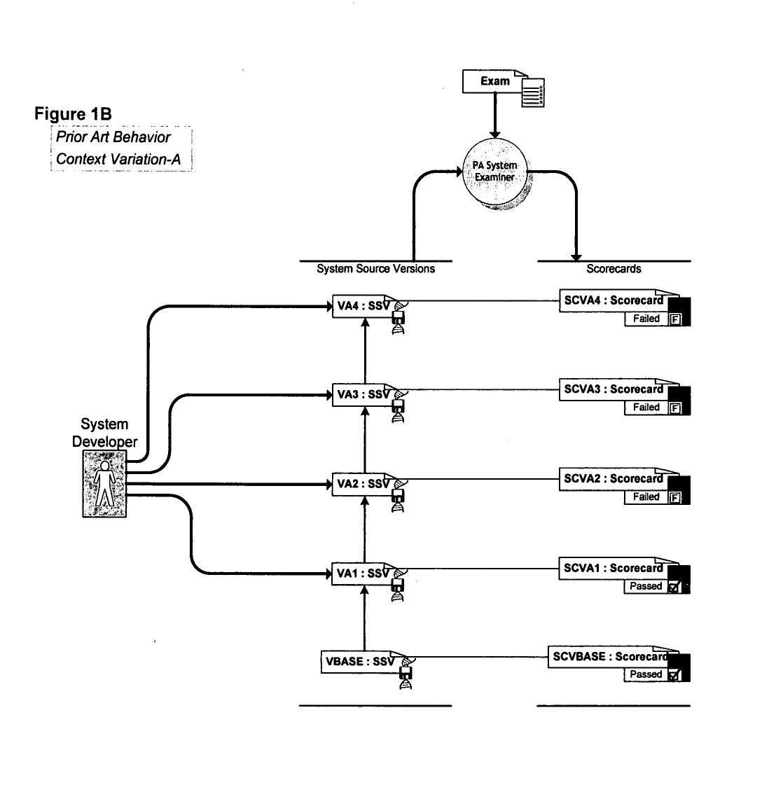

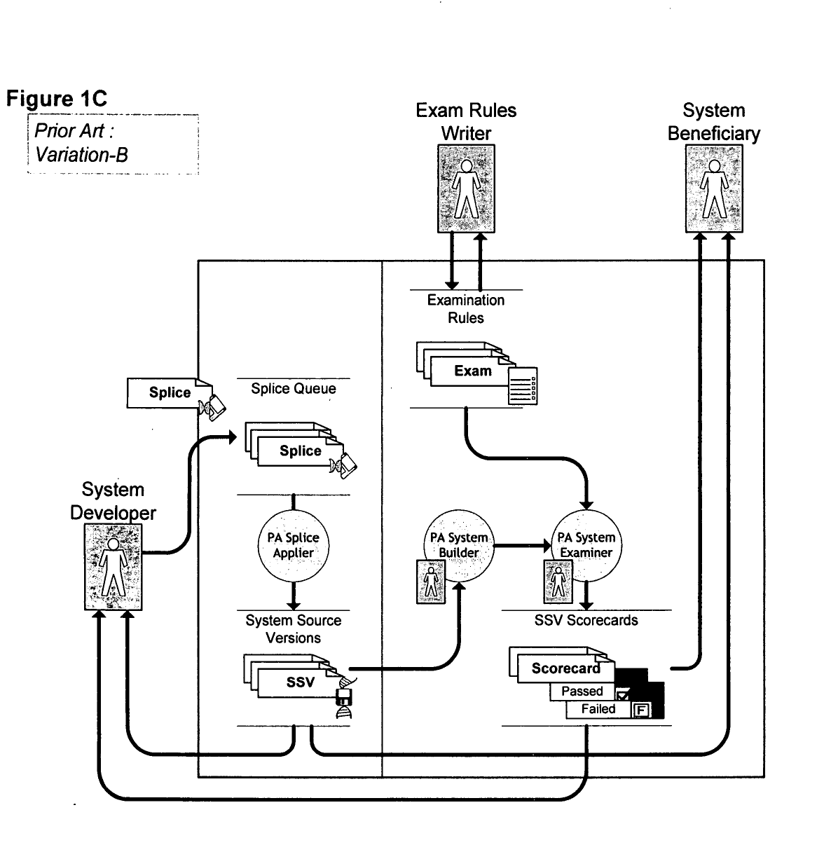

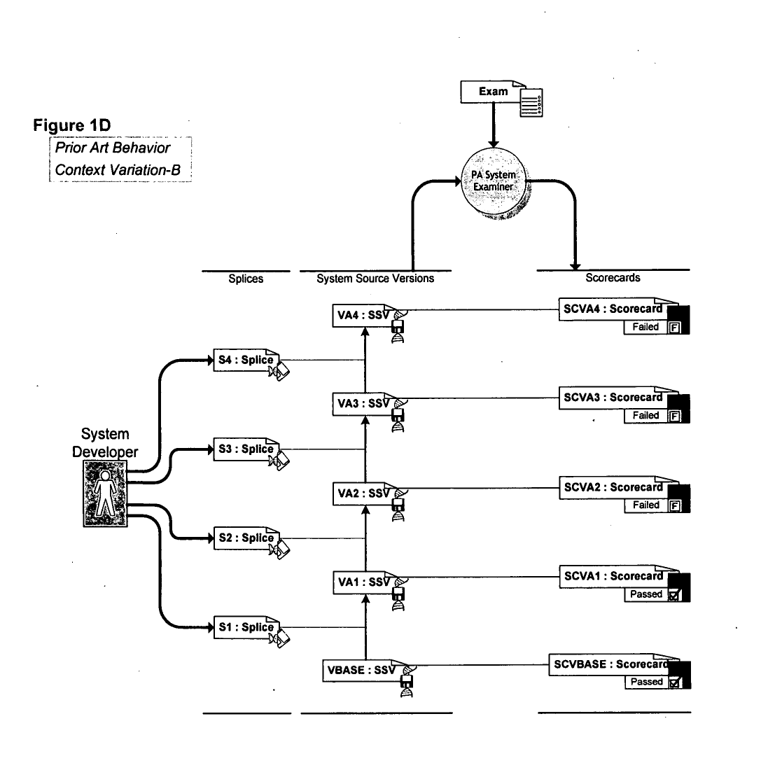

### DETAILED DESCRIPTION OF THE INVENTION

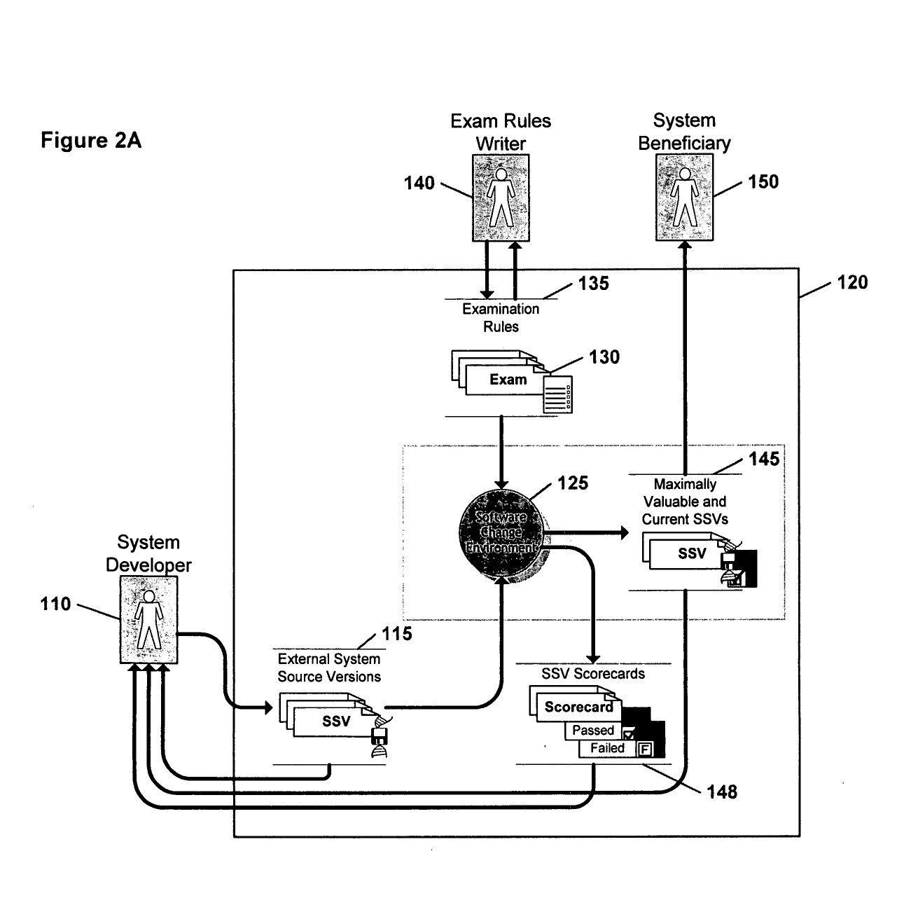

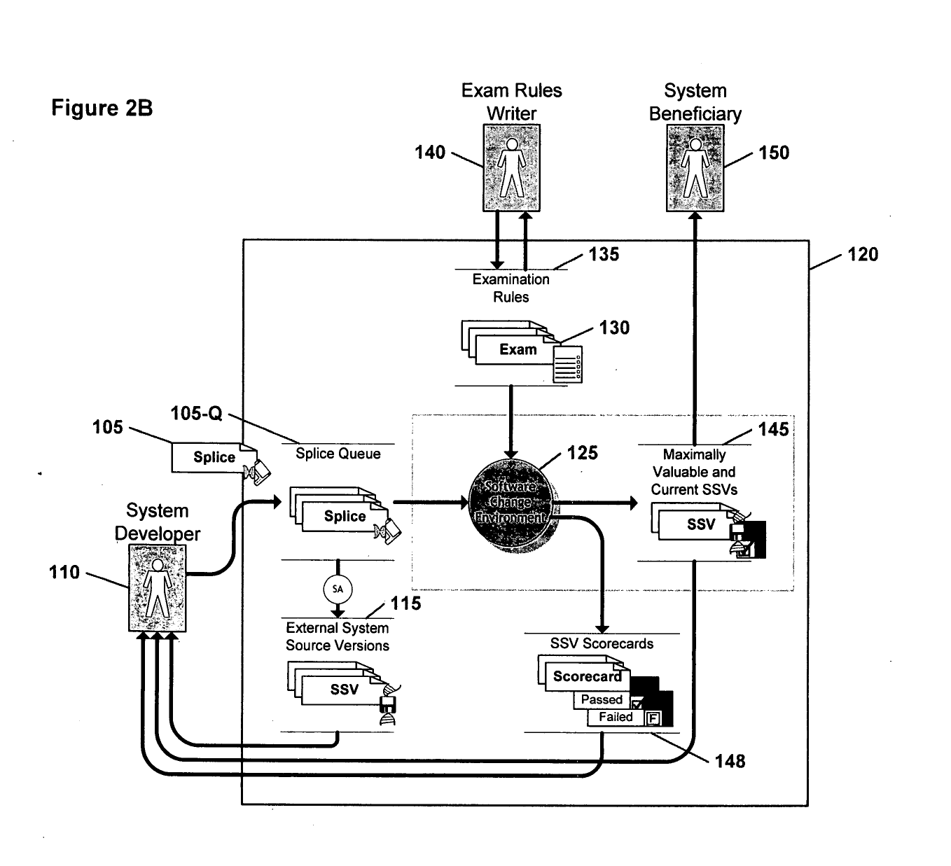

Referring to FIGS. 2A and 2B for two alternate functional block diagrams for illustrating the configuration of a system and the process flow for carrying out changes to a software system. The system includes a system developer working on a client data handling system 110 and a server data handling system 120. The client data handling system 110 generates “splice submissions” for submitting to the server data handling system 120. A “splice” 105 is a collection of changes to a software system parceled together into a unit. Beyond the collection of changes made to the software system, a splice includes additional information about the creator of the changes, the time of the changes, the version of the software system the changes are based on, and other contextual and purpose-oriented augmentations. Within the software industry, a splice is analogous to the term “change set”, “patch”, “delta”, etc. Although the preferred embodiments of this invention are described with a term splice, the set of common characteristics for the similar terms as listed above are encompassed by the concept of the term “splice” and considered as synonymous with these other terms. A “system source version” (SSV) 115 is the collection of information that can be utilized to create an object-version of a software system, e.g., full application, module, library, etc.

The server data handling system 120 receives the splice 105 from the client data handling system 110 and places the splice into a splice queue 105-Q as shown in FIG. 2B. The system 120 may receive an external SSV 115 from the system developer 110 as shown in FIG. 2A. The server data handling system provides a software change process environment 125 to carry out automated software change and test operations by applying a set of quality-test examinations 130 that is generated according to a set of examination rules 135 provided by a software quality test team 140 comprises an examination rule writer. In addition to automated software change and test operations, the software change process environment 125 of this invention carries out further operations, as will be described in more specific details below, to generate the maximum valued SSV and the current version of SSV 145 that is available to the system beneficiary 150, e.g., a customer as the user of the updated software system. The software system change environment as part of the server 120 further store the scoreboard of different SSVs and the failed-passed status of each SSV in the scoreboard 148.

According to above figures and descriptions, the software system as shown is comprised of the following major software functional components: a change parceler, e.g., a splice generator, a change-parcel accepter, e.g., a splice receiver, a change-parcel grader, e.g., a system examiner, a system builder, e.g., a SSV generator, a system grader, e.g., the system examiner, a system publisher, a process manager, a communicator, a source manager, an examination manager, and a review information manager.

In comparison to the conventional software change systems, the software change environment disclosed in this invention provides superior system development productivity, greater system quality, and improved team development processes. The improvements are achieved by providing a change environment to automate, orchestrate, and optimize a process cycle, specifically as shown in FIGS. 2A and 2B, a Change-Build-Evaluate-Feedback cycle. The software change system of this invention produces versions of the software system that optimize the software change quality by (a) maximizing the examination scores of the system, and by (b) including the latest changes that System Developers 110 or automated processes have created. The core behavior as shown in the system diagrams is to create Maximally Current and Valuable SSVs 145 that enables the System Beneficiaries 150 to utilize a higher-quality system that is as current as possible, and the System Developers 110 to be far more productive by (a) having regressive changes weeded out by quantifying a failed system with a low score thus automatically eliminating the application of a failed SSV, (b) identifying the source of the regression and possibly fixing the root cause through the examination process when different types of examination rules are applied, (c) sharing a higher-quality system as the standard among the team, and (d) getting feedback very swiftly.

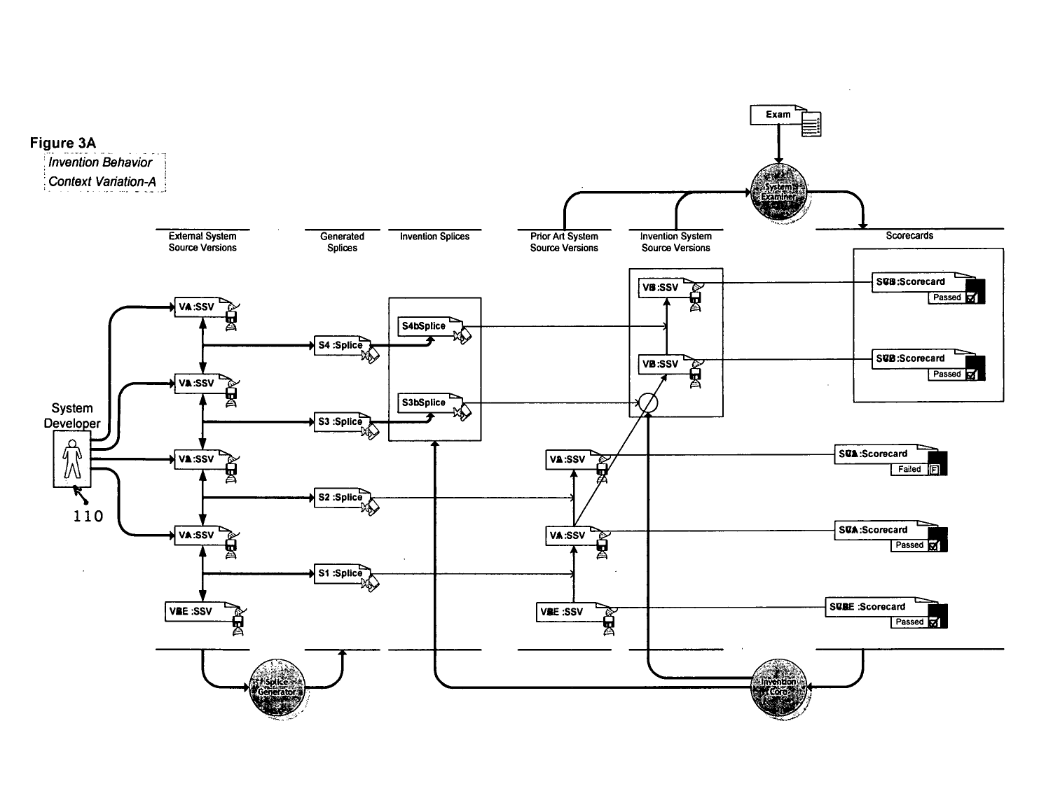

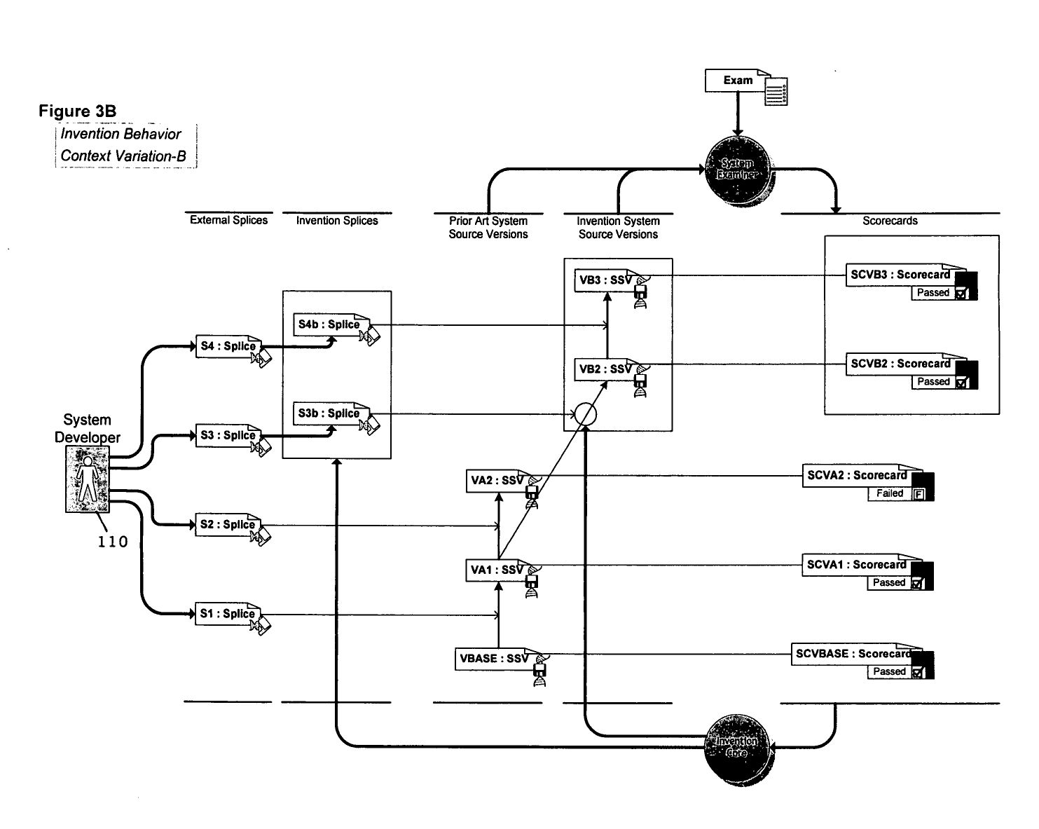

Referring to FIGS. 3A and 3B for the processes carried out by the server 120 for four different SSVs or four splices respectively. In FIG. 3A, a system developer 110 provides a base version SSV, e.g., VBASE, and four updated versions of SSVs, e.g., VA1, VA2, VA3, VA4. A splice generator generates four splices S1, S2, S3, and S4 as splices based on the VBASE. In FIG. 3B, a system developer 110 provides four splices S1, S2, S3, and S4. According the diagram and process as described in FIGS. 2A and 2B, the examinations have already confirmed that other than VA2, and S2 the other three SSVs and splices pass the test. The software change environment of this invention enables the generation of new System Source Versions (SSVs) from the most recent changes that have better scores than the system source versions as often generated by a conventional software change process. This diagram shows a very simple and common example of eliminating the regression from a failed SSV as that may occur in the conventional systems. In shown in FIGS. 3A and 3B, VA2 failed, but despite this failing, VA3 and VA4 continued to be based on VA2—so they failed as well even though they may have been examined successfully if their changes were applied on top of VA1. Due to the fact that the SSV VB2 version has failed, the software change environment branches its generation and application of Splices to create an alternative “VB2: SSV” that includes all the changes that are added as part of VA3, but applies those changes on top of VA1. Given VB2 is of maximum examined value, it would be the one published as Maximally Valuable and Current instead of VA2. Continuing with the process, the software change environment of this invention creates VB3 and since this version scores well, it would be published as maximally valuable and more current than VB2. VA2, VA3, and VA4 would be demoted so others did not accidentally use or base their changes off of them.

Additionally, the software change environment of this invention may also publish that VA2 (alone) was the cause of the problem and swiftly feed back that source of failing to the System Developer to rectify the defect and the failing to the development quality review personnel to identify if there was a root cause of the defect.

The improved behavior enables the System Beneficiaries to utilize a higher-quality system that is as current as possible, and the System Developers to be far more productive by (a) having regressive changes weeded out for them, (b) identifying the source of the regression and possibly fixing the root cause, (c) sharing a higher-quality system as the standard among the team, and (d) getting feedback very swiftly.

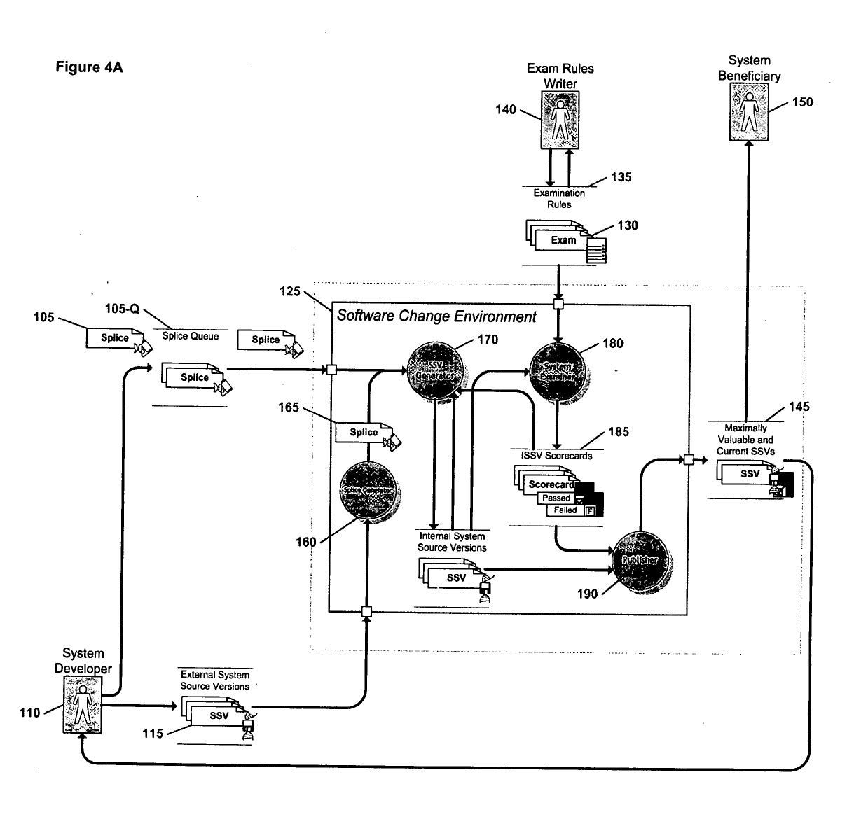

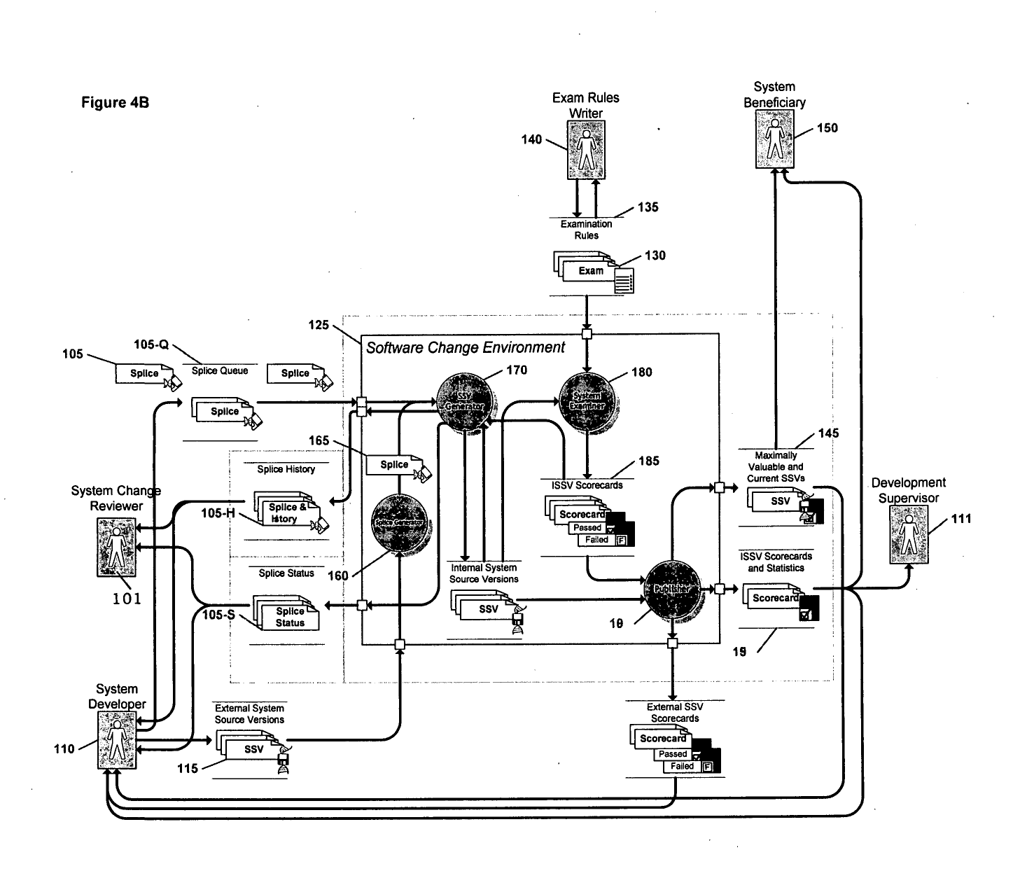

Referring to FIG. 4A for more detail descriptions of the operations carried out in the software change environment 125 of this invention. A system developer 110 develops a new SSV 115 for submitting to the server after a system change reviewer 101 reviews the SSV 115. The software change environment 125 includes a splice generator 160 to process the SSV 115 to generate a splice 165. The newly generated splice 165 is stored in a splice history database 105-H with the status of the splice stored in a splice status database 105-S. The splice 165 with the base version of a software then applied by a SSV generator 170 to generate a normalized and sanitized SSV for examination by a system examiner 180 that applies examination rules 135 generated by an examination rule writer 140. The SSV normalization and sanitization processes will be further described below. The system examiner 180 carries out software tests to produce SSV scoreboards to reflect the level of quality of the SSV as a changed version of the software system depending on the results of the tests under different test rules. The scoreboard is then published by a publisher 190 and the scoreboard and the results of the test are further stored in the maximum value and current SSVs database 145 and the scoreboard database 195 available for use by a system beneficiary 150 and for review by a software development supervisor 111. FIG. 4B illustrates basically a similar system configuration as that shown in FIG. 4A where the splices 105 instead of SSVs are generated and stored in a splice queue 105-Q for inputting inputted to the software change environment 125 of this invention.

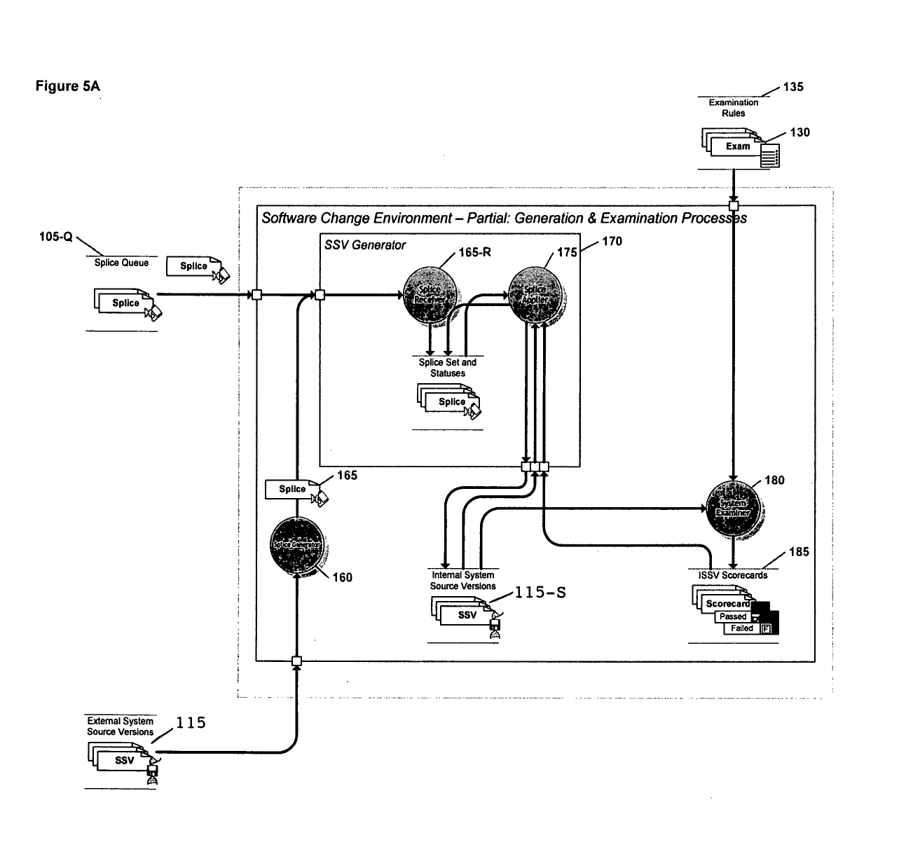

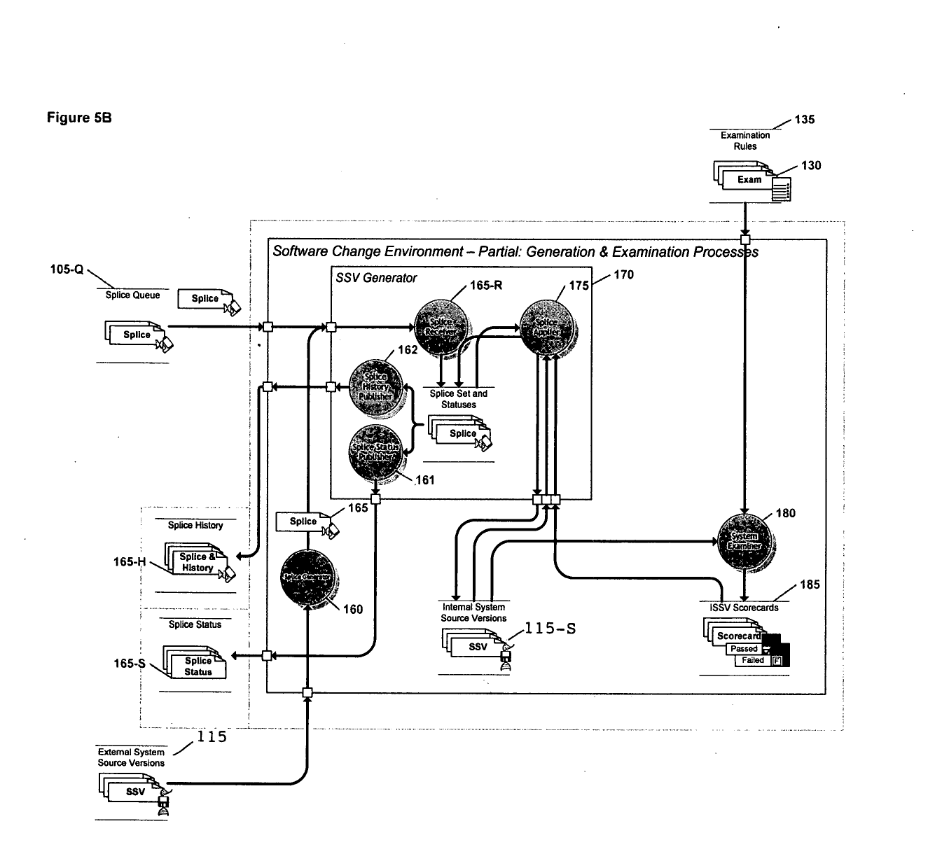

Referring to FIGS. 5A and 5B for additional details for the SSV generator 170. In FIG. 5A, a splice 165 is generated from a splice generator 160 and receive by a splice receiver 165-R or alternately a splice from a splice queue is provided to the splice receiver 165-R. The SSV generator further includes a splice applier 175 to apply the splice 165 received from the splice receiver 165-R to the SSV 115 to generate a new SSV for submitting to the system examiner 180. The system examiner 180 then applies examination rules 130 to carry out different types of tests to generate a score to store in the scoreboard 185. The tested SSVs with different test scores are also stored in an internal SSV database 115-S. FIG. 5B is an alternate embodiment where the splice is submitted either from the splice queue 105-Q or from the splice generator 165. A special feature disclosed in this invention is a feedback of data and information from the SSV score board 185 back to the splice applier such that depending on the test score of an SSV and a corresponding splice, the splice is either applied when the test score shows a high value or removed if the test score shows a low value or failure such that a maximum value and current SSV can be generated and published after the SSVs that that applied different splices are tested. The tested SSVs with different test scores are also stored in an internal SSV database 115-S. The SSV generator 170 further includes a splice status publisher 161 and a splice history publisher 162 to publish splice status 165-S and splice history 165-H.

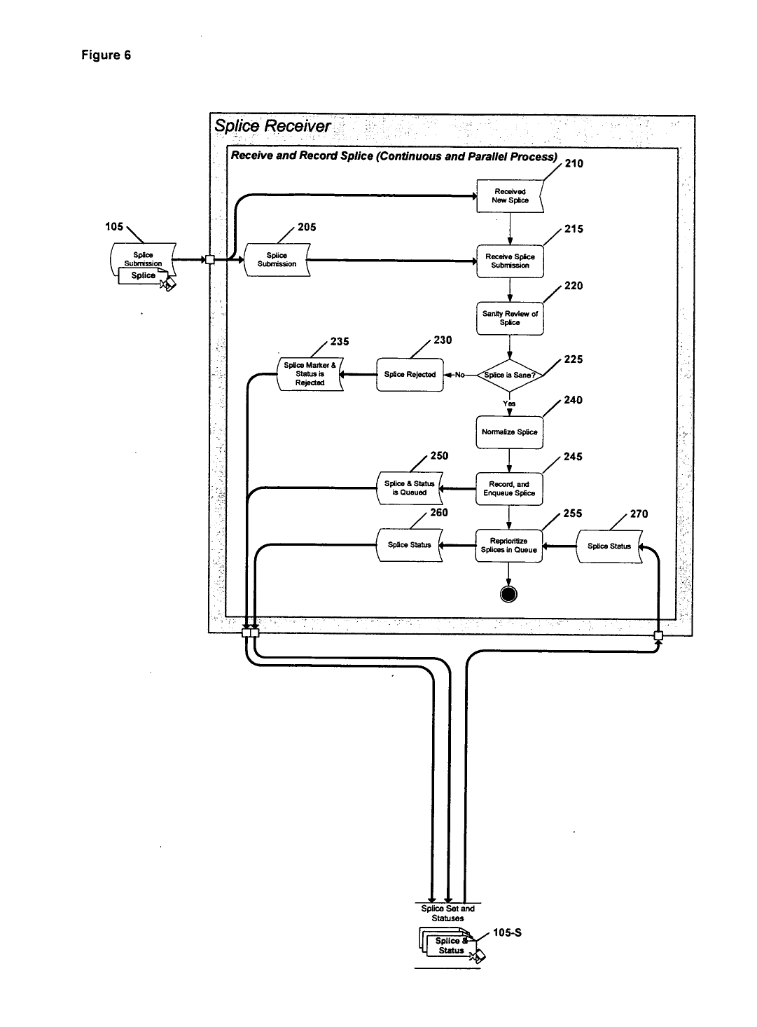

FIGS. 6 to 8 below are flowcharts to show the macro level control flow in the standard flowchart notations. Note that the preferred embodiment of the system is both multi-threaded and configurable, so a simple flowchart is only a basic representation of its behavior. The detailed descriptions provide additional information of the software change environment implemented in a server and the benefits of the systems disclosed in this invention.

FIG. 6 is a flowchart showing the processing steps carried out by a SSV receiver 165-R. A splice 165 is generated from a splice generator 160 and submitted and processed in a splice submission process 205. Alternately, a new splice may be submitted to a new splice process 210. The splice is received into the software change environment in process 215 and splice sanity review is first conducted (step 220). A determination is made to evaluate whether the splice passes the sanity check (step 225), if it fails, then the splice is rejected (step 230) and the splice is marked as rejected and the status is stored in a splice status database (step 235). If the splice passes the sanity review, then a normalization process 240 is carried out to normalize the splice by correcting typographical errors, and other software informalities, irregularities, or small inconsistencies. The normalized splice is recorded and queued (step 245). The splice status is also queued. (step 250). As time passes, the splice in the queue is reprioritized (step 255) and the splice status is updated (step 260) when a splice status update request is received (step 270) from the splice status database.

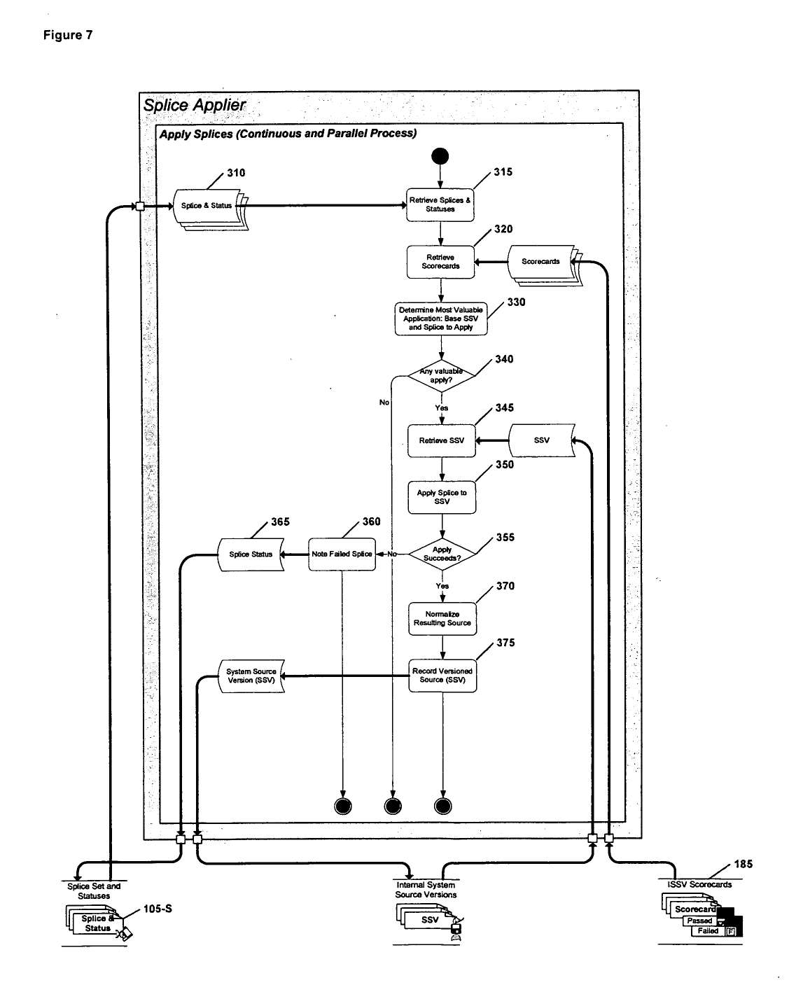

FIG. 7 is a flowchart for illustrating the processes carried out by a splice applier 175 as part of the software change environment 125 of this invention. The splice applier 175 first checks check the status of the splice (step 310) and retrieves the splices and the statuses (step 315) and further retrieves the scoreboards 185 from the SSV and scoreboard database 195 (step 320). An evaluation process is carried out to determine the most valuable application based on the scoreboards and the statuses of the splices (step 330). An evaluation is performed to determine if there is any valuable application according to the scoreboards 185 and the statuses of different splices available (step 340). If there is no valuable application, then the process starts over again to wait for new splices and new statuses. If there is a valuable application, an SSV 115-R is retrieved from a SSV database (step 345) and the splice is applied to the SSV (step 350). After the application, a process is performed to determine if the application is successful (step 355), and if the process fails, the system is notified of the application failure (step 360) and a status is added to the splice (step 365) before the splice and the status are stored into the SSV database and the splice status database. When an application is successful, a normalization process is performed to the resulting source codes to assure all the typographic errors, the informalities, irregularities and inconsistencies are corrected. (step 370). The new version of SSV after the splice application is then recorded (step 375) and a new version of SSV 115-New is generated and stored in the SSV database 115.

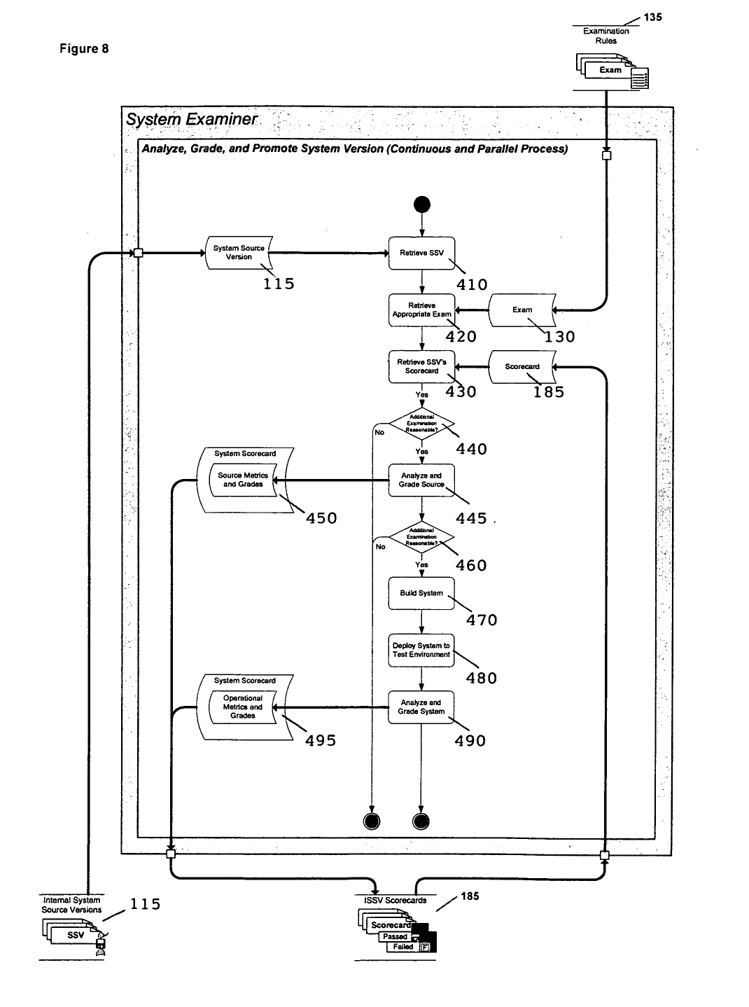

FIG. 8 is a flowchart for showing the processing steps carried out by a system examiner 180 as part of the processes performed in the system software change environment 125 of this invention. The system examiner starts the process by retrieving a SSV 115 from the SSV database for examination (step 410). The system examiner then retrieves an examination 130 from an examination database 140 (step 420). The system examiner further retrieves a scoreboard 185 from a scoreboard and statistics database 195 (step 430). According to the scoreboard 185 and the status data, the system examiner then evaluates if additional examination is required and reasonable (step 440). If it is not required to carry out further examination, then the process starts over again to wait for new SSV and new scoreboard. If it is evaluated that additional examinations would be reasonable, then a process to analyze source and grade the source is performed (step 445) to generate a new system with system metrics and grades (step 450). A next level test evaluation is performed to determine additional examination would be reasonable (step 455), and if not, then the process starts over again. If it is determined that additional examination would be reasonable, then a system is built (step 470) and the newly built system is deployed to the test environment (step 480) followed by a process to analyze and grade the system (step 490) to generate a new system scoreboard and the operational metrics and grades as the results of such examinations (step 495).

From above descriptions, the software change environment 125 of this invention includes a splice generator 160 and SSV generator 170, a system examiner 180 a publisher 190 and a SSV scoreboard repository 195. The core responsibilities of each of these components are as follows. The Splice Generator 160 creates Splices from the SSV in the SSV repository 115 and submits them to the SSV Generator 170. The SSV Generator 170 takes the submitted Splices, SSVs, and the SSVs Scorecards 195 and creates new SSVs based on those Splices and Scorecards. The System Examiner 180 takes SSVs from the SSV Repository 115, examines and scores them with an Exam from the Examination Rules repository 130, and records their score into the Scorecards Repository 195. The Publisher 190 takes the Scorecards and the SSVs and publishes which SSVs are maximally valuable and current. The combined responsibility of the Splice Generator 160, SSV Generator 170, and System Examiner 180 together is to produce maximally valuable and current SSVs. The Publisher 190 then publishes their results so actors are benefited from the automated tests and the SSVs that have the maximum value according to the test scores. Based on the system configuration and the processes as described above, a machine, e.g. the server data handling system with the software change environment 125 of this invention is enabled to execute an improved process of changing software systems that results in maximally valuable and current versions of the software system given sets of changes and examination rules.

The machine, e.g., the server data handling system that includes the software change environment 125, orchestrates and automates activities from the parceling of a change to a software system, through the application of that change against a software system, through evaluating the quality of the resulting software system, and to automatically publishing the knowledge gained and derivable from the system and these activities. The machine automates this process with superior behavior and results, and makes the progress of the process visible to humans and other systems.

According to above descriptions, this invention discloses a data handling system that includes a software change processor for applying a software change to a software system and employing a set of software quality examination rules to evaluate and generate a quality score of the software system after application of said changes. The data handling system further providing the quality score as a reference for applying a software change to a software system. In a preferred embodiment, the software change processor further generates a score to quantify the quality after employing the set of software quality examination rules.

The software change systems as disclosed in this invention may potentially receive client Splices simultaneously and will need to handle all of those Splices whether they are consistent with each other or not. In somewhat more detail, the process would include process of receiving, recording and queuing the splices for further processes. The software change system may also include process to recognize and resonate the queue if a new splice or any other changes should affect the processes of applying the splices.

As shown in FIG. 7, the splice applier will operate continuously to apply splices (both recent and old) to SSVs as: (a) more splices are received, or (b) more information is gained from the SSV evaluations (the Scorecards). As shown in FIG. 7, the splice applier takes the following actions 1) Chose the “most valuable to splice at this time” Splice. 2) Normalize the Splice: transform it to conform to the standards for Splices by this software system. 3) Apply the Splice to the most “valuable to splice” SSV at this time, which could be the latest SSV or a different SSV that matches a different criteria of valuable selection. 4) Normalize the resulting SSV. 5) Record the resulting source in a versioned, retrievable fashion. If the Splice is invalid innately or with regards to the chosen SSV, it will be rejected. At the end of each completion of activity, the process carried out by the splice applier will start again with a new Splice and SSV, as long as there are additional valuable SSVs to produce.

As shown in 8, the system examiner is operated continuously to apply and evaluate SSVs as: (a) more SSVs exist, (b) more scoring could be done for a given Exam, or (c) new Exams are added that are appropriate (and valuable to score) for this SSV. The processes carried out by the system examiner can be summarized as: 1) Retrieve the “most valuable to evaluate” at this time version of the SSVs; 2) Analyze and grade the source itself; 3) Build an object-version of the software system from that source; 4) Deploy that object-version into one or more execution environments; 5) Examine and grade the behavior and other characteristics of those executing systems. At the end of each completion of activities performed by the system examiner, it will start again with a new SSV and Exam, as long as there are additional valuable evaluations to be made. Additionally, the processes carried out by the system examiner could be repeated for the same SSV and Exam if the system examiner only scores a portion of the full Exam that a SSV should be graded by in a given pass.

In summary, this invention discloses an automated software development system that includes an automated version control and evaluation processing platform for automatically evaluating a quality and value of a plurality of software changes and corresponding versions of a software system for automatically controlling an automated software development and change process of the software system. In a preferred embodiment, the automated version control and evaluation processing platform further includes a database for storing statistic and relevant data including the quality and value of the plurality of software changes and versions of the software system. In a preferred embodiment, the automated version control and evaluation processing platform further applying the statistic and relevant data for automatically controlling an automated software development and change process of the software system.

The invention includes manifesting behavior beyond the simple apparent pipeline because of multiple feedback loops of information and the actions within the activities. Based on the grading, promote or demote the rank of the system—Promotion can include new tagging (new visible rank and number), deployment to production, etc. After each iteration of examination, more knowledge of the system will be gained and the SSV could be promoted to higher and higher ranks. In accordance with the present invention, a machine executes an improved process of changing software systems. The machine orchestrates and automates activities from the packaging of a change to a software system, through the application of that change against a software system, through evaluating the quality of the resulting software system, and to automatically deploying (or otherwise acting on) the resulting, evaluated, system. The machine both automates this process and makes the progress of the process visible to humans and other systems.

According to the functional block diagrams shown in FIGS. 2, 4, and 5 and above flowcharts, the core process the machine follows is divided into two activities. A) A client process that parcels a set of changes that the client desires to be applied to a software system, and submits that parcel to the Server process; and B) A server process that receives and processes those parcels against that software system. The activity of client processes can be done by any number of actors (people or machines), at the same time, and without regards for the other actors and their set of changes. The machine process involves activities will be receiving client parcels potentially nearly simultaneously and will need to handle all of those client parcels whether they are consistent with each other or not. The standard process the server follows can be categorized as 1) receiving and processing the parcel into the main source system version control and 2) analyzing, grading, and promoting that resulting source system version based on the new parcel.

In somewhat more detail, the process for carried out by the server would be as follows: 1a) Receive, record, and enqueue the parcel for processing; 1b) Review the parcel for “sanity”—is it interpretable, is it up to date with the main code line, will it directly conflict with another parcel that has higher priority than this parcel, etc. 1c) Normalize the parcel: transform it to conform to the standards for parcels by this software system. 1d) Apply the change parcel to the current version of the source of the software system for the development branch this parcel is intended for 1e) Normalize the resulting source. 1f) Record the resulting source in a versioned, retrievable fashion.

The second category of activities carried out by the server can be summarized as: 2a) Retrieve the version of the source for a change parcel; 2b) Analyze and grade the source itself; 2c) Build an object-version of the software system from that source 2d) Deploy that object-version into one or more execution environments; 2e) Examine and grade the behavior and other characteristics of those executing systems 2f) Based on the grading, promote or demote the rank of the system—Promotion can include new tagging (new visible rank and number), deployment to production, etc. These processes could be repeated if the system examiner only examines a portion of the full criteria that a system should be graded by. After each iteration of examination, more knowledge of the system will be gained and the system could be promoted to higher and higher ranks.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A data handling system comprising:
a software change processor for applying a software change to a software system and employing a set of software quality examination rules to evaluate a quality of said software system after application of said change for automatically referencing to said quality of said software system and said software change to automatically determine a future application of said software change.

2. The data handling system of claim 1 wherein:
said software change processor further generates a score to quantify said quality after employing said set of software quality examination rules.

3. The data handling system of claim 2 wherein:
said software change processor further evaluating whether to apply said software changes according to said score representing a quantified quality of said software change.

4. The data handling system of claim 1 wherein:
said software change processor further generates different level of scores to quantify said quality after employing different sets of software quality examination included in said set of software quality examination rules.

5. The data handling system of claim 1 wherein:
said software change processor further generates a score to quantify said quality after employing said set of software quality examination rules; and
said data handling system further include a database to store a maximum value version of system software after comparing said score for each of different software changes in generating different versions of said software systems.

6. The data handling system of claim 1 wherein:
said software change processor further generates a score to quantify said quality after employing said set of software quality examination rules; and
said data handling system further include a database to store said score and additional relevant data linking to each of different software changes and correspondent version of said software system.

7. The data handling system of claim 1 further comprising:
a software change queue for receiving a plurality of software changes.

8. The data handling system of claim 1 further comprising:
a software change generator for receiving a new version of said software system to generate a new software change.

9. The data handling system of claim 1 further comprising:
an examination rule database for storing said examination rules.

10. The data handling system of claim 1 wherein:
said software change processor further includes an automatic software testing system for applying said examination rules to evaluate a quality of said software system after applying said software change.

11. A data handling system comprising:
an automated software change and version control processing platform for applying a plurality of software changes to generate a plurality of software system versions and automatically employing a set of software quality examination rules to evaluate a quality of each of said plurality of software system versions for automatically determining a maximum value current version among said plurality of software system versions.

12. The data handling system of claim 11 wherein:
said automated software change and version control processing platform further logging statistic and relevant data for each of said plurality of software changes and software system versions including said quality for each of said plurality of software system versions.

13. The data handling system of claim 12 wherein:
said automated software change and version control processing platform further applying said statistic and relevant data for each of said plurality of software changes and software system versions.

14. An automated software development system comprising:
an automated version control and evaluation processing platform for automatically evaluating a quality and value of a plurality of software changes and corresponding versions of a software system for automatically controlling an automated software development and change process of said software system.

15. The automated software development system of claim 14 wherein:
said automated version control and evaluation processing platform further including a database for storing statistic and relevant data including said quality and value of said plurality of software changes and versions of said software system.

16. The automated software development system of claim 15 wherein:
said automated version control and evaluation processing platform further applying said statistic and relevant data for automatically controlling an automated software development and change process of said software system.

17. A method for automating a software development process comprising:
providing a software change environment for applying a software change to a software system to generate a changed version of said software system followed by employing a set of software quality examination rules to evaluate a quality and value of said changed version of said software system for automatically referencing to said quality and value of said changed version to determine a future application of said software change and said changed version.

18. The method of claim 17 wherein:
said step of employing a set of software quality examination rules to evaluate a quality and value of said changed version of said software system further includes a step of generating a score to quantify said quality after employing said set of software quality examination rules.

19. The method of claim 18 wherein:
said step of automatically referencing to said quality and value of said changed version to determine a future application of said software change and said changed version further includes a step of evaluating whether to apply said software changes according to said score representing a quantified quality of said software change.

20. The method of claim 17 wherein:
said step of employing a set of software quality examination rules to evaluate a quality and value of said changed version of said software system further includes a step of generating different level of scores to quantify said quality after employing different sets of software quality examination included in said set of software quality examination rules.

21. The method of claim 17 wherein:
said step of employing a set of software quality examination rules to evaluate a quality and value of said changed version of said software system further includes a step of generating a score to quantify said quality after employing said set of software quality examination rules; and
providing database to store a maximum value version of system software after comparing said score for each of different software changes in generating different versions of said software systems.

22. The method of claim 21 wherein:
said step of providing a database further includes a step of storing said score and additional relevant data linking to each of different software changes and correspondent version of said software system.

23. The method of claim 17 further comprising:
providing a software change queue for receiving a plurality of software changes.

24. The method of claim 17 further comprising:
providing a software change generator for receiving a new version of said software system to generate a new software change.

25. The method of claim 17 further comprising:
providing an examination rule database for storing said examination rules.

26. The method of claim 17 wherein:
said step of employing a set of software quality examination rules to evaluate a quality and value of said changed version of said software system further includes a step of employing an automatic software testing system for applying said examination rules to evaluate a quality of said software system after applying said software change.

27. A method to automated a software development process comprising:
automatically evaluating a quality and value of a plurality of software changes and corresponding versions of a software system for automatically controlling an automated software development and change process of said software system.

28. The method of claim 27 further comprising:
storing statistic and relevant data including said quality and value of said plurality of software changes and versions of said software system in a database.

29. The method of claim 28 further comprising:
applying said statistic and relevant data stored in said database for automatically controlling an automated software development and change process of said software system.
